(19) United States
(12) Patent Application Publication
(10) Pub. No.: US 2013/0106029 A1
(43) Pub. Date: May 2, 2013

(54) Fabrication of High Energy Density Battery

(71) Applicant: INFINITE POWER SOLUTIONS, INC., Littleton, CO (US)

(72) Inventors: Shawn W. Snyder, Golden, CO (US); Alexandra Z. LaGuardia, Denver, CO (US); Damon E. Lytle, Golden, CO (US); Bernd J. Neudecker, Littleton, CO (US)

(73) Assignee: INFINITE POWER SOLUTIONS, INC., Littleton, CO (US)

(21) Appl. No.: 13/661,619

(22) Filed: Oct. 26, 2012

Related U.S. Application Data
(60) Provisional application No. 61/552,330, filed on Oct. 27, 2011.

(51) Int. Cl. B29C 43/20

(52) U.S. Cl. 264/571; 264/104

(57) ABSTRACT

A method for making an electrochemical cell includes, for example, providing a cathode powder; and pressing the cathode powder at a pressure of more than 500 bar and less than 10000 bar, resulting in a pressed cathode body with a pressed porosity of more than 5 vol % and less than 60 vol %.

This invention claims the benefit of U.S. Provisional Patent Application No. 61/552,330 filed on Oct. 27, 2011, which is hereby incorporated by reference in its entirety.

### BACKGROUND OF THE INVENTION

1. Field of the Invention

The field of embodiments of the invention relate to fabrication of an electrochemical cell with the goal to maximize its energy density for a given electrochemically active cathode material, a given electrolyte layer, and a given negative anode layer.

2. Discussion of the Related Art

The capacity of rechargeable and non-rechargeable batteries is primarily defined by the positive cathode and the negative anode. When using a metallic lithium anode or a capacity rich Li-ion anode, for example, the capacity of the battery is primarily dominated or limited by the specific capacity of the positive cathode (capacity per unit volume or unit mass of cathode). Thus, increasing the electrochemically active mass inside the positive cathode (while also, for example, reducing the volume of all of the other battery components, which may be most useful for small batteries, or the mass of all of the other battery components, which may be most useful for large batteries) is an effective approach to increase the energy density of a battery for a given cathode-anode chemistry. Some exemplary batteries and battery fabrication methods are described, for example, in U.S. Pat. No. 8,021,778, U.S. Patent Publication No. 2007/0184345 and U.S. Patent Publication No. 2009/0162755, which are incorporated herein by reference in their entirety.

There is a need in the industry for batteries with higher energy densities.

### SUMMARY OF INVENTION

Accordingly, embodiments of the invention are directed to, for example, fabrication of a high density battery that substantially obviates one or more of the problems due to limitations and disadvantages of the related art.

An object of embodiments of the invention is to increase the volumetric or gravimetric capacity of a cathode, which is a function of the least conductive species (electrons or ions) within the cathode so as to both increase the ionic conductivity of the cathode and decrease the porosity of the cathode.

Another object of embodiments of the invention is to increase the ionic conductivity of a cathode.

Another object of embodiments of the invention is to tune the porosity of a cathode.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a method for making an electrochemical cell includes, for example, providing a cathode powder; and pressing the cathode powder at a pressure of more than 500 bar and less than 10000 bar, resulting in a pressed cathode body with a pressed porosity of more than 5 vol % and less than 60 vol %.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a cross-sectional view of a pressed cathode body without electrolyte according to an embodiment of the invention.

FIG. 2 is a cross-sectional view of a pressed cathode body with solid state electrolyte material according to an embodiment of the invention.

FIG. 3 is a cross-sectional view of a pressed cathode body soaked with liquid electrolyte according to an embodiment of the invention.

FIG. 4 is a cross-sectional view of a pressed cathode body with solid state electrolyte material and soaked with liquid electrolyte according to an embodiment of the invention.

FIG. 5 is an exemplary method for making a compressed cathode according to embodiments of the invention.

FIG. 6 is a cross-sectional view of a powder press for compressing homogenously mixed powders according to embodiments of the invention.

FIG. 7 is a cross-sectional view of an electrochemical cell with solid state electrolyte material and soaked with liquid electrolyte according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. Embodiments of the invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

Embodiments of the invention are not limited to the particular methodology, compounds, materials, manufacturing techniques, uses, and applications described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements, and includes equivalents thereof known to those skilled in the art. Similarly, for another example, a reference to “a step” or “a means” is a reference to one or more steps or means and may include sub-steps or subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices and materials are described although any methods, techniques, devices, or materials similar or equivalent to those described may be used in the practice or testing of the present invention.

All patents and other publications discussed are incorporated herein by reference for the purpose of describing and disclosing, for example, the methodologies described in such publications that might be useful in connection with the present invention. These publications are provided solely for their disclosure prior to the filing date of the present application. Nothing in this regard should be construed as an admission that the inventors are not entitled to antedate such disclosure by virtue of prior invention or for any other reason.

A cathode can include, for example, electrochemically active cathode material, ionic conductivity enhancer material (electrolyte material), electronic conductivity enhancer material (often some form of carbon), binder material, and additional auxiliary materials that may fine-tune the interaction between the previous materials and/or the mechanical properties of the cathode. The volumetric or gravimetric capacity of a cathode may be determined, for example, by: (1) porosity in the cathode volume; and (2) ionic conductivity inside the cathode. The electronic conductivity of many electrochemically active cathode materials is typically higher than their ionic conductivity, such as in the case of lithium ion conducting cathode materials. Therefore, it can be desirable to identify the optimum combination of cathode porosity, which may be filled by a material that provides high ionic conductivity, such as an electrolyte material, rather than the electrochemically active cathode material itself For example, the ionic conductivity of a cathode can be enhanced by, for example, a liquid electrolyte material that is composited into the cathode. The porosity of a cathode can be fine-tuned through the pressures applied during cathode powder compaction into pressed cathode body. Increasing the electrochemically active mass inside the positive cathode may include either reducing any auxiliary phases inside the cathode, such as mechanical binders or ionic or electronic conduction enhancers, or making the cathode thicker for a given cathode area.

Certain exemplary embodiments of this invention can include making batteries with higher energy density for a given cathode-anode chemistry by creating a certain amount of porosity in a pressed cathode body and adjusting the ionic conductivity of this cathode, as provided, for example, by the addition of an electrolyte material into the cathode. A method for making an electrochemical device may include pressing a positive cathode powder at a pressure of more than 500 bar and less than 10000 bar, resulting in a pressed cathode body with a pressed porosity of more than 5% and less than 60%.

The energy density (measured in Wh/liter for volumetric energy density or Wh/kg for gravimetric energy density) of an electrochemical cell having a cathode, an electrolyte, a negative anode, and peripherals, such as, for example, current collectors, terminals and encapsulation/packaging can be characterized, for example, by the volumetric capacity (Ah/liter) or gravimetric capacity (Ah/kg) of the positive cathode or compartment. The volumetric or gravimetric capacity is sometimes also called specific capacity. The volumetric or gravimetric capacity of the cathode can translate into the respective volumetric or gravimetric energy density, respectively, of the electrochemical cell when the volumetric and gravimetric contributions of the other components inside the electrochemical cell are included and the then so-obtained volumetric or gravimetric capacity of the entire electrochemical cell can be multiplied by the electrode potential difference between the positive cathode and the negative anode. More specifically, specific energy of the electrochemical cell =specific capacity of the electrochemical cell * “midpoint” cell voltage.

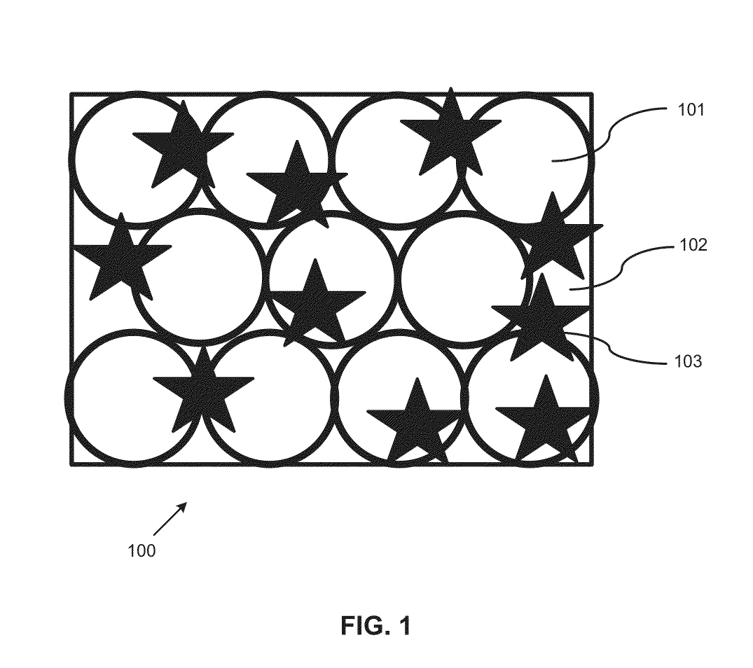

Typically, a cathode can include an electrochemically active cathode material and various auxiliary materials, such as electrolyte material (ionic conductivity enhancer material), binder material, and electronic conductivity enhancer material. FIG. 1 is a cross-sectional view of a pressed cathode body without electrolyte according to an embodiment of the invention. As shown in FIG. 1, a cathode 100 includes an electrochemically active cathode material 101 with pores 102 amongst the binder material 103. The volumetric or gravimetric capacity of a cathode containing a given electrochemically active cathode material may be determined, for a given discharge current rate, for example, by: (1) porosity in the cathode volume; and (2) ionic conductivity inside the cathode. The electronic conductivity of many electrochemically active cathode materials is typically higher than their (lithium) ionic conductivity. Since the least conducting species (electrons or ions) inside the cathode can determine the current rate capability of the cathode (defined as capacity delivery under a certain discharge current) and therefore the cathode's volumetric or gravimetric capacity, which in turn affects the energy density of the entire electrochemical cell, one may maximize the cathode's (lithium) ionic conductivity and minimize the cathode's porosity.

The ionic conductivity and electronic conductivity, which may be intrinsically higher than the ionic conductivity, in a cathode is relevant to sustaining the discharge process. The discharge process, or energy providing process, of an electrochemical cell includes the moving of ions (moving cell-internally) and electrons (moving cell-externally) from the negative anode to the positive cathode. Insufficient ionic conductivity in a cathode may limit the extent of the discharge. Thus, the cathode material in deeper regions of the cathode may not discharge, which may limit the cathode's volumetric or gravimetric capacity. In the alternative or in addition, insufficient ionic conductivity may limit the speed at which the discharge can be conducted such that current rate capability is limited. Therefore, ionic conductivity inside the cathode should be enhanced at least until it reaches or exceeds the level of the electronic conductivity before enhancing the electronic conductivity inside the cathode.

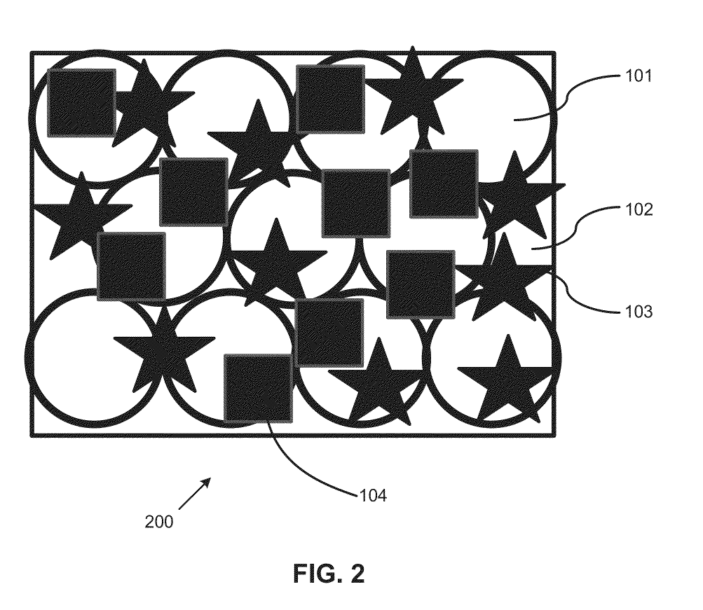

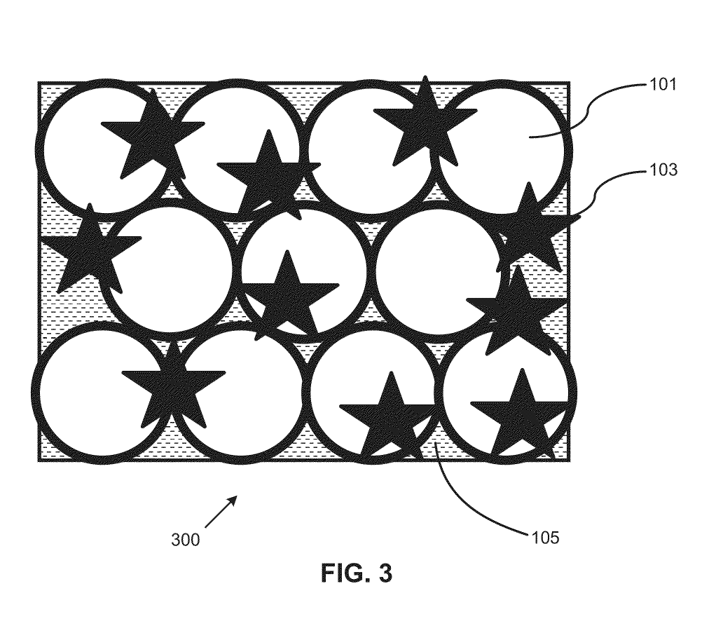

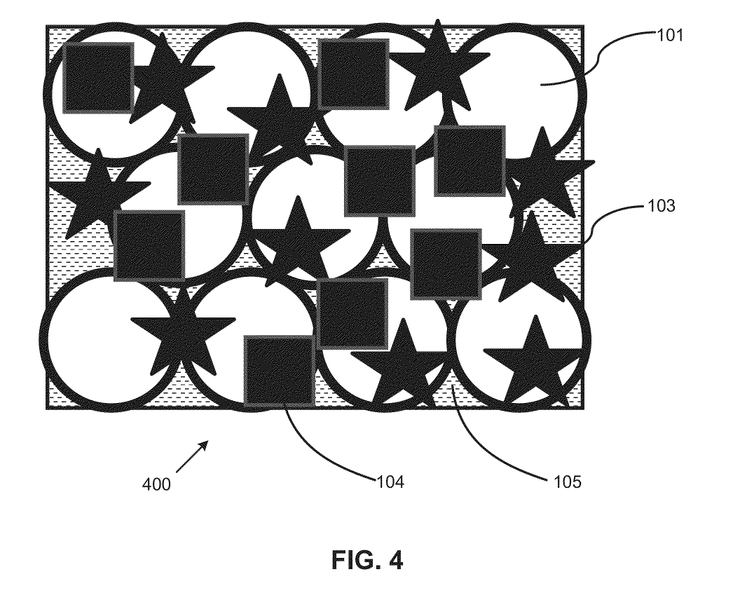

The ionic conductivity of a cathode can be enhanced by a solid state electrolyte material or liquid electrolyte material that is composited into the cathode. FIG. 2 is across-sectional view of a pressed cathode body with solid state electrolyte material according to an embodiment of the invention. As shown in FIG. 2, a cathode 200 includes an electrochemical active cathode material 101 with pores 102 amongst the electrolyte material, solid state electrolyte material 104 and binder material 103. FIG. 3 is across-sectional view of a pressed cathode body soaked with liquid electrolyte according to an embodiment of the invention. As shown in FIG. 3, a cathode 300 includes an electrochemically active cathode material 101 with liquid electrolyte material 105 amongst the binder material 103. In another alternative, ionic conductivity of a cathode can be enhanced by both a solid state electrolyte material and a liquid electrolyte material that is composited into the cathode. FIG. 4 is a cross-sectional view of a pressed cathode body with solid state electrolyte material and soaked with liquid electrolyte according to an embodiment of the invention. As shown in FIG. 4, a cathode 400 includes an electrochemically active cathode material 101 with liquid electrolyte material 105 amongst the solid state electrolyte material 104 and binder material 103. Solid state electrolyte material may be fabricated into a cathode at the time of the cathode fabrication while liquid electrolyte material may be composited into the cathode by a liquid-soak, capillary-action process (which may be performed in a vacuum or otherwise) into the cathode pores after the manufacturing of the cathode or the rest of the electrochemical cell has been otherwise completed (without the addition of the liquid electrolyte). Pores may exist in all materials that are not 100% dense, such as pressed cathodes or cathodes fabricated through various other battery fabrication methods (such as, for example, vapor phase deposition, slurry coating, etc.).

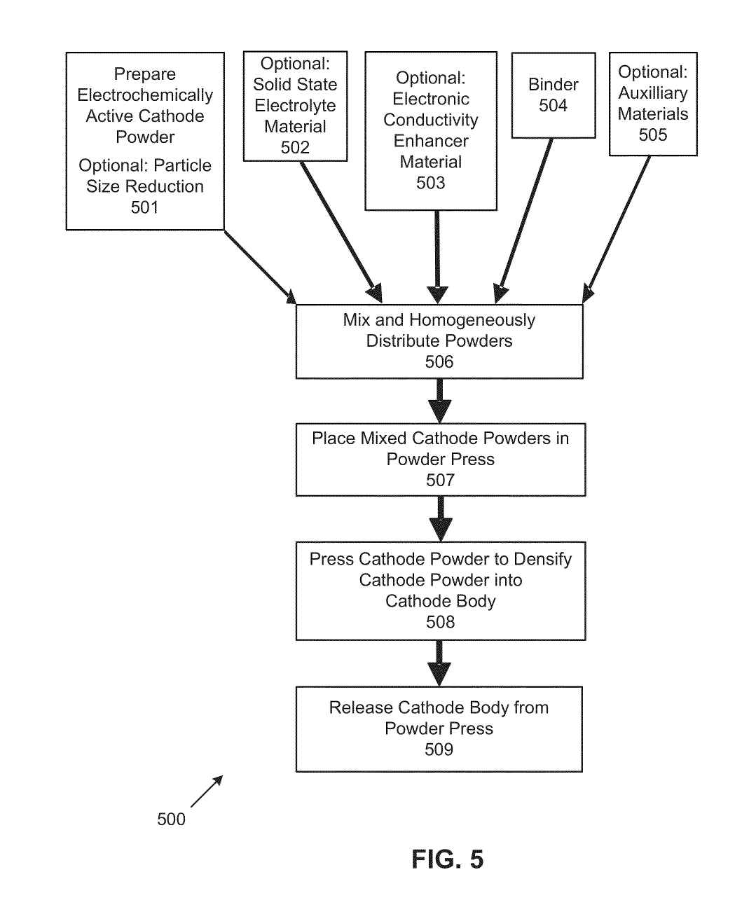

FIG. 5 is an exemplary embodiment for a method of making a compressed cathode according to embodiments of the invention. As shown in FIG. 5, the method 500 includes mixing 506 and homogenously distributing at least an electrochemically active cathode powder 501 and a binder 504 into a mixed cathode powder. Optionally, one or more of a solid state electrolyte material 502, an electronic conductivity enhancer material 503 and auxiliary materials 505 can also be mixed and homogenously distributed into a mixed cathode powder. Subsequently, the mixed cathode powder is placed 507 into a powder press 507. Then, the mixed cathode powder is pressed 508 to densify the cathode powder into a cathode body. After the pressing 508, the cathode body is released 509 from the powder press.

The cathode powder may, for example, consist of only electrochemically active cathode material or also may include, for example, binder material, among others. The cathode powder may include materials such as, for example, LiCoO₂, LiNiO₂, LiMnO₂, Li₂MnO₃, LiMn₂O₄, LiV₂O₄, LiFePO₄, MnO₂, V₂O₅, Ag₂V₄O₁₁, CFₓ (0.5<x<4), and any derivatives or combinations thereof. The size of the cathode powder particles may also be varied to, in certain instances, improve performance or capacity. For example, the make-up of the cathode particles may be such that at least 50% of the mass of said cathode powder consists of particles that are less than 20 μm along their main axis (the main axis of a particle being, for example, the longest distance across the particle). Furthermore, particle sizing may also be accomplished by, for example, ball-milling of a parent cathode powder where at least 50% of said parent cathode powder's mass includes particles that are, for example, substantially larger than 20 μm along their main axis and wherein after the ball-milling at least 50% of the parent cathode powder's mass include particles that are substantially less than 20 μm along their main axis.

The binder material may include poly(vinylidene fluoride), poly(vinylidene fluoride—co-hexafluoropropylene), poly(ethylene glycol) dimethyl ether, poly(vinyl alcohol), carboxymethylcellulose, diacetyl cellulose, poly(vinyl chloride), carboxylated poly(vinyl chloride), poly(vinyl fluoride), ethylene-oxide containing polymer, poly(vinyl pyrrolidone), poly(urethane), poly(tetrafluoroethylene), styrene-butadiene rubber, acrylated styrene-butadiene rubber, nylon, surlyn, or polyvinyl butyral resin. After pressing said positive cathode powder, said cathode body may be subjected to a heat treatment at less than 50° C. below the melting point or decomposition point of said binder. The solid state electrolyte material may include a single inorganic phase that has an ionic bulk conductivity higher than about 10⁻⁶ S/cm, such as Li_{3.4}Si_{0.4}P_{0.6}O₄ or Li₇La₃Zr₂O₁₂. More preferably, the solid state electrolyte material consists of a composite comprising an inorganic salt, such as, for instance, lithium bis(trifluoromethylsulfonyl) imide, lithium bis(fluorosulfonyl)imide, lithium trifluoromethylsulfonate, lithium hexafluorophosphate, or lithium tetrafluoroborate. This inorganic salt can then be composited with a solid polymeric matrix, such as, for instance, poly(vinylidene fluoride), poly(vinylidene fluoride—co-hexafluoropropylene) or poly(ethylene glycol) dimethyl ether (molecular weight larger than 1000). To increase the ionic conductivity of the composite electrolyte one may add ethylene carbonate (solid at room temperature), which, due to its high dielectric constant, better separates the anion from the Lithium cation in these inorganic salts. Optionally, an inert solid state phase, such as magnesium oxide, may be added to the composite to fine-tune the mechanical properties of the solid state electrolyte material. This then so-created solid state electrolyte can be added to the cathode to provide it with sufficiently high ionic conductivity.

The molten organic salt liquid electrolytes may include at least one cation including, for example, pyrrolidinium, pyrrolidinium derivatives, imidazolium, imidazolium derivatives, phosphonium, phosphonium derivatives, organic ammonium, organic ammonium derivatives, choline, choline derivatives, pyrazolium, pyrazolium derivatives, pyridinium, pyridinium derivatives, piperidinium, piperidinium derivatives, morpholinium, morpholinium derivatives, sulfonium, and/or sulfonium derivatives. The molten organic salt liquid electrolytes may include at least one anion including, for example, hexafluorophosphate, hexafluoroantimonate, tetrafluoroborate, bis(trifluoromethylsulfonyl)imide, bis(fluorosulfonyl)imide, chloride, bromide, iodide, dicyanamide, acetate, methylcarbonate, methylsulfate, nitrate, tetrachloroaluminate, thiocyanate, trifluoromethanesulfonate, hydrogen carbonate, and/or dibutylphosphate.

In embodiments of the invention in which a solid state electrolyte material exists in the cathode, it may be desirable to reduce the porosity by densifying the cathode, which includes solid state electrolyte material, binder material, and an optional electronic conductivity enhancer material. Such a reduction of porosity can be, to a practical maximum, using some means of densification, such as mechanical pressing during cathode fabrication. For instance, a residual porosity of 5 vol % inside an entirely solid state cathode can accommodate the inherent volume changes without major stress or pressure build-up that the electrochemically active cathode material undergoes during the charge and discharge processes. As an example, the popular electrochemically active cathode material, LiCoO₂, increases by 2 vol % during its charge to 4.2V vs. Li⁻/ Li and contracts back to its starting volume during the discharge process to 3.0V vs. Li⁺/Li. A larger porosity in the cathode may allow for more volume changes in the electrochemically active cathode material thereby entailing even less stress or pressure build-up in the cathode. However, too large of a porosity reduces the volumetric or gravimetric capacity of the cathode and is therefore less desirable.

Because a solid state electrolyte generally does not actively provide capacity to the cathode due to its pre-eminent property of electrochemical inertness, its presence consumes volume in the cathode that could otherwise be occupied by electrochemically active cathode material that in turn would increase the volumetric or gravimetric capacity of the cathode. On the other hand, the solid state electrolyte inside a cathode can improve the ionic conductivity of the cathode thereby increasing the current rate capability of the cathode. Based on these opposing effects of the presence of the solid state electrolyte an optimum electrolyte volume or mass can exist inside a given cathode under which a given cathode delivers its maximum volumetric or gravimetric capacity under a given current rate. Generally, at very low current rates very little solid state material is needed to access the entire capacity of a cathode whereas at higher current rates a cathode can, for example, be loaded with more solid state electrolyte material in order to involve as much of the electrochemically active cathode material during the charge and discharge processes as possible.

Suitable solid state electrolytes may be a single inorganic phase, such as, for instance, crystalline Li_{3.4}Si_{0.4}P_{0.6}O₄, which is a solid solution of Li₄SiO₄ in crystalline Li₃PO₄ matrix. Other known inorganic electrolyte materials may be used instead of Li_{3.4}Si_{0.4}P_{0.6}O₄. Composite or multi-phase solid state electrolytes may be used as well, such as, for instance, lithium bis(trifluoromethylsulfonyl) imide mixed into poly(vinylidene fluoride—co-hexafluoropropylene) and ethylene carbonate, which may contain an optional inert inorganic phase, such as magnesium oxide.

It may be preferred to use that electrolyte which exhibits the highest ionic bulk conductivity and the highest ionic interface conductivity at the grain boundaries of the electrochemically active cathode material. If one of these two ionic conductivities is low, then the electrochemically active cathode material may not be able to properly utilize that given electrolyte material inside the cathode, which would result in poor volumetric or gravimetric capacity of the cathode and eventually poor energy density of the entire electrochemical cell. It has been found that it is difficult to achieve good ionic interface conductivity at the grain boundaries of the electrochemically active material when using single-phase inorganic electrolytes, such as Li_{3.4}Si_{0.4}P_{0.6}O₄. In contrast, much better ionic interface conductivity at the grain boundaries of the electrochemically active material can be attained when employing composite electrolytes that contain a rather soft and conforming polymeric matrix, such as lithium bis(trifluoromethylsulfonyl) imide mixed in poly(vinylidene fluoride—co-hexafluoropropylene) and ethylene carbonate, which may comprise an optional inert inorganic phase such as magnesium oxide. As a result, pressed cathodes utilizing such an electrolyte can achieve much higher mass densities and therefore lower porosities under practical pressure processing, namely down to about 5 vol % porosity of the total cathode volume.

Relative to porosity and ionic conduction, the same principles as mentioned above can apply to cathodes when they include a liquid electrolyte. There may be a slight difference between cathodes that contain a solid state electrolyte versus a liquid electrolyte, though, because the liquid electrolyte can be capable of filling up the pores in the cathode with electrolyte material. In an embodiment of the invention having no solid state electrolyte in the cathode, the porosity volume of the densified cathode can be the space that is maximally available to the liquid electrolyte. In the intermediate embodiment, where a solid state electrolyte material and a liquid electrolyte material are used together in the cathode, the total electrolyte volume inside the cathode can be larger than that of the porosity. In this case, the densified cathode containing solid state electrolyte material can be equipped with additional ionic conduction enhancer material, namely the liquid electrolyte in the pores, otherwise the porosity may remain unused and only occupied with inert gas which may not improve the performance of the cathode.

During the liquid-soak capillary-action process, liquid electrolyte fills up some, most or all of the porosity within the cathode volume. There are two factors, for example, that may affect the ionic conductivity of a cathode: (1) the amount of liquid electrolyte in the cathode volume after filling up the cathode's porosity; and (2) the intrinsic ionic conductivity of that liquid electrolyte. The amount of porosity in the cathode volume determines the amount of liquid electrolyte that can fill up that porosity in whole or in part. The higher the concentration of a given liquid electrolyte within the cathode, generally results in the higher the ionic conductivity of the cathode. Therefore, a higher concentration of a liquid electrolyte inside a given cathode, made possible by a higher porosity, allows for a higher ionic conductivity of the cathode.

The ionic conductivity of the cathode is also determined at least in part by the intrinsic ion conductivity of the liquid electrolyte filling the porosity of the cathode. To form a cathode with a certain overall ionic conductivity, the cathode may require a lesser concentration of liquid electrolyte (and therefore a lower porosity within the cathode) if a liquid electrolyte with an intrinsically higher ionic conductivity is used. In contrast, the cathode may require a higher concentration of liquid electrolyte (and therefore a higher porosity within the cathode) if a liquid electrolyte with a lower intrinsic ionic conductivity is used to form a cathode with the same overall given ionic conductivity.

The ionic conductivity of a cathode soaked with liquid electrolyte is lower than the intrinsic ionic conductivity of the pure (100%) liquid electrolyte that contains no cathode material. On the other hand, any porosity inside the cathode that is not filled with electrochemically active cathode material may reduce the specific capacity of the cathode or may result in a cathode having a lower specific capacity than a cathode filled to a greater extent. Because it is often a preference or goal to attempt to optimize the specific capacity of a cathode, it may be desirable to identify the optimum amount of porosity, which may be filled with liquid electrolyte, for a given ionic conductivity inside the cathode or to identify the optimum amount of ionic conductivity inside the cathode for a given amount of cathode porosity. In other words, it may be desirable to optimize the relationship between, and identify the optimum combination of, cathode porosity and lithium ionic conductivity that may be supplied to the cathode by the liquid electrolyte, and the selection of an electrochemically active cathode material itself

Some liquid electrolytes may be based on organic molten salt, and are sometimes also called ionic liquids. These liquid electrolytes can be stable against metallic Li anodes and 4.2V (vs. Li⁻/Li) LiCoO₂ cathodes, and therefore may be some of the preferred liquid electrolytes for processes such as, for example, a liquid-soak capillary-action process. The most stable liquid electrolytes in this category of electrolytes may, for example, exhibit an ionic conductivity of up to about 5*10⁻³ S/cm or more at room temperature when in pure form. When soaked (composited) into a cathode , the ionic conductivity may decrease to, for example, between about 5*10⁻⁴ S/cm and 10⁻⁵ S/cm, depending on the concentration of the ionic liquid inside the cathode and the tortuosity of the pores inside the cathode matrix. In an embodiment of the invention, the ionic conductivity in a cathode can be the product of porosity multiplied by the ionic conductivity of the electrolyte in pure form. When, for instance, a given liquid electrolyte in pure form exhibits 5*10⁻³ S/cm of ionic conductivity, then a cathode porosity of about 10% may be preferred to achieve an ionic conductivity of about 5*10⁻⁴ S/cm inside the cathode. If, in a different example, the lithium ion conductivity of the pure liquid electrolyte is relatively low, for example, about 10⁻⁴ S/cm, then the porosity in the cathode preferably have to be relatively high, for example about 50% to achieve at least about 50%*10⁻⁴ S/cm=5*10⁻⁵ S/cm of ionic conductivity in the cathode

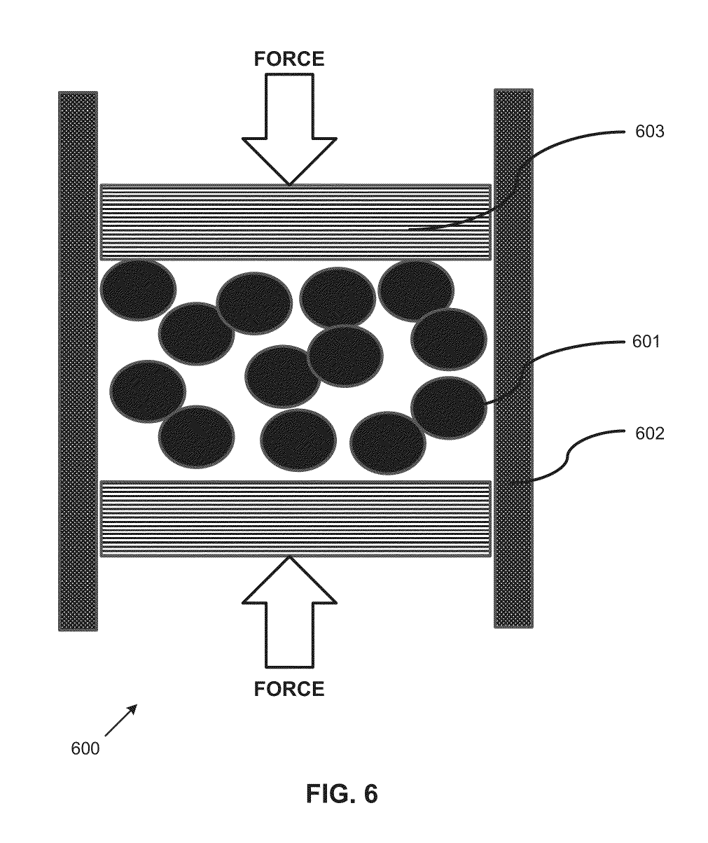

FIG. 6 is a cross-sectional view of a powder press for compressing homogenously mixed powders according to embodiments of the invention. As shown in FIG. 6, the powder 601 is positioned between the walls 602 of the powder press 600 and the anvils 603 that apply force to the powder 601. The porosity of a cathode material can be fine-tuned, for example, through the pressures applied during cathode powder compaction into pressed cathode body (the cathode powder may be pressed at room temperature or at higher temperatures, for example at temperatures above 50° C., above 60° C., above 140° C., or higher). For example, applying different amounts of pressure to LiCoO₂, MnO₂ or V₂O₅ cathode powders may cause the resulting electrochemical cells (for instance, LiCoO₂/ lithiated anode, MnO₂/Li or V₂O₅/Li, respectively) to have substantially different discharge performances. More specifically, applying a pressure of between about 500 bar and about 10000 bar, for example 1000 bar, to the positive cathode powder may yield an electrochemical cell with substantially improved discharge performance than applying about 10000-21000 bar of pressure to the same cell with the same configuration and using the same liquid electrolyte, such as lithium bis(fluorosulfonyl)imide dissolved in 1-Methyl-3-propyl-pyrrolidinium bis(fluorosulfonyl)imide. The improved discharge performance resulting from the above referenced tuning through pressures may be up to about 10 times or more in energy density of the electrochemical cell. Pressing a cathode powder at a pressure of between about 500 bar and about 10000 bar may result in a pressed cathode body with a pressed porosity of less than about 60% and more than about 5%, respectively. On the other hand, when applying about 10000-21000 bar of pressure, the increased pressure may create less porosity available for the liquid electrolyte to fill inside the cathode as verified by the measured mass uptake of the liquid electrolyte into the cathode.

As for cathodes composited with a solid state electrolyte, the porosity—pressure relationship may be about the same, for example, where 500 bar of cathode densification pressure can yield about 60 vol % of cathode porosity and 10000 bar may approach about 5 vol % of porosity in the cathode. The difference compared to the cathodes that may be impregnated with liquid electrolyte is that it may be desirable to achieve low porosity in cathodes with solid state electrolytes so that their preferred porosity—pressure parameter set approaches, for example, 5 vol % and 10000 bar.

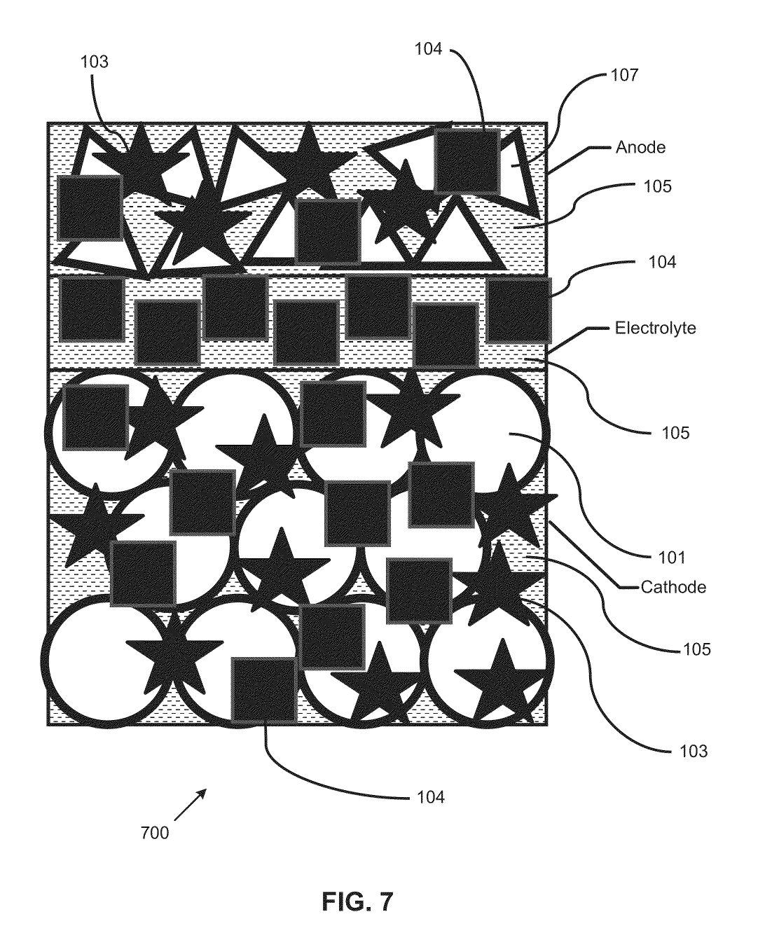

FIG. 7 is a cross-sectional view of an electrochemical cell with solid state electrolyte material and soaked with liquid electrolyte according to an embodiment of the invention. As shown in FIG. 7, an electrochemical cell 700 includes an cathode layer with electrochemically active cathode material 101, an electrolyte layer with solid state electrolyte material 104 and an anode layer with electrochemically active anode material 107. The anode and cathode layers can also have solid state electrolyte materials 104. The anode and cathode layers can also contain binder materials 103. The liquid electrolyte material 105 can be in the anode, electrolyte and cathode layers.

An electrolyte layer may be pressed against the positive cathode powder before or after the pressed cathode body is created. The electrolyte layer may consist of the same materials as the solid state electrolyte that is composited into the cathode. Alternatively, the electrolyte layer may include one or more electronically insulating materials, including, for example, metal oxides, metal nitrides, metal sulfides, metal fluorides, metal chlorides, metal bromides, metal iodides, borates, carbonates, silicates, germanates, nitrates, phosphates, arsenates, sulfates, selenates, oxyfluorides, oxychlorides, oxybromides, oxyiodides, oxynitrides, carbides, carbonitrides, poly(vinylidene fluoride), poly(vinylidene fluoride—co-hexafluoropropylene), poly(tetrafluoroethylene), polyacrylates, polyethylene, polypropylene, polyester, polyamides, polyimides, polyethers, polycarbonates, polysulfones, and silicones, which can be soaked with liquid electrolyte employing a capillary-action process after the electrolyte layer composed of any of the above-listed electronically insulating materials is fabricated.

A negative anode layer may be fabricated on the side of the electrolyte layer not contacting the cathode. The anode layer may be fabricated by pressing anode material onto the electrolyte layer or vice versa. The anode material may be a single phase, such as, for instance, a lithium metal foil or a composite comprising lithium ions, metal ions, carbon, lithiated carbon, polymeric binder and electrolyte material. Latter may be solid state and, in that embodiment, is composited into the anode material in a similar fashion as the solid state electrolyte material into the cathode. The anode material may be formed by methods such as ball-milling, further comprising priming the walls of the ball-mill vessel with a film of metallic lithium powder. The negative anode layer consisting of anode material may include, for example, metallic lithium, metal or metallic alloy that may not alloy with metallic lithium or may only form a solid solution with metallic lithium, or lithium ion anode material that is capable of simultaneously storing lithium ions and electrons. The negative anode layer may also include, for example, lithium-aluminum alloy, lithium-silicon alloy, lithium-tin alloy, lithium-zinc alloy, lithium-gallium alloy, lithium-indium alloy, lithium-germanium alloy, lithium-phosphorus alloy, lithium-arsenic alloy, lithium-antimony alloy, and lithium-bismuth alloy.

Liquid electrolyte may, for example, be soaked into the pores of the pressed cathode body, into the pores of the electrolyte layer, and/or into the pores of the negative anode layer after the negative anode layer has been attached to said electrolyte layer.

Other parameters and processes may help to improve the volumetric and gravimetric capacity of a given cathode and therefore the energy density of the electrochemical cell, such as reducing the particle size of the cathode powders using, for example, ball-milling prior to cathode pressing, provision of a cathode current collector, omission of additional electronic enhancer materials into the cathode, addition of binder materials to the cathode powders during pressed cathode body formation, heat treatment after pressing of a composited cathode body, and liquid electrolyte soaking into the cathode under vacuum conditions.

The embodiments and examples described above are exemplary only. One skilled in the art may recognize variations from the embodiments specifically described here, which are intended to be within the scope of this disclosure and invention. As such, the invention is limited only by the following claims. Thus, it is intended that the present invention cover the modifications of this invention provided that they come within the scope of the appended claims and their equivalents.

What is claimed is:

1. A method for making an electrochemical cell, comprising:
providing a cathode powder; and
pressing the cathode powder at a pressure of more than 500 bar and less than 10000 bar, resulting in a pressed cathode body with a pressed porosity of more than 5 vol % and less than 60 vol %.

2. The method of claim 1, wherein said cathode powder is pressed at room temperature.

3. The method of claim 1, wherein said cathode powder is pressed at temperatures higher than 50° C.

4. The method of claim 1, wherein said cathode powder includes only electrochemically active, positive electrode material.

5. The method of claim 1, wherein said cathode powder comprises binder material.

6. The method of claim 5, wherein said binder is, after pressing of said positive cathode powder, subjected to a heat treatment at less than 50° C. below the melting point or decomposition point of said binder.

7. The method of claim 5, wherein said binder comprises a material from the group of: Poly(vinylidene fluoride); poly(vinylidene fluoride—co-hexafluoropropylene); poly(ethylene glycol) dimethyl ether,; poly(vinyl alcohol); carboxymethylcellulose; diacetyl cellulose; poly(vinyl chloride); carboxylated poly(vinyl chloride); poly(vinyl fluoride); ethylene-oxide containing polymer; poly(vinyl pyrrolidone), poly(urethane); poly(tetrafluoroethylene); styrene-butadiene rubber; acrylated styrene-butadiene rubber; nylon; surlyn; and polyvinyl butyral resin.

8. The method of claim 1, wherein at least 50% of the mass of said cathode powder consists of particles that are less than 20 μm along their main axis.

9. The method of claim 8, further comprising particle sizing accomplished by ball-milling of a parent cathode powder wherein at least 50% of said parent cathode powder's mass includes particles that are substantially smaller than 20 μm along their main axis.

10. The method of claim 1, further comprising soaking a liquid electrolyte into the pores of said pressed cathode body after said pressing.

11. The method of claim 10, further comprising supplying lithium ion conductivity to said cathode by said liquid electrolyte.

12. The method of claim 11, wherein said lithium ion conductivity is between about 10⁻³ S/cm and about 10⁻⁵ S/cm.

13. The method of claim 10, wherein said soaking is performed in a vacuum.

14. The method of claim 10, wherein said soaked liquid electrolyte is held in place by said cathode via capillary action so that said liquid electrolyte does not escape said cathode by gravity action.

15. The method of claim 10, wherein said liquid electrolyte is a molten organic salt containing at least one dissolved lithium containing salt.

16. The method of claim 15, wherein said molten organic salt comprises:
at least one cation selected from the group: pyrrolidinium, pyrrolidinium derivatives, imidazolium, imidazolium derivatives, phosphonium, phosphonium derivatives, organic ammonium, organic ammonium derivatives, choline, choline derivatives, pyrazolium, pyrazolium derivatives, pyridinium, pyridinium derivatives, piperidinium, piperidinium derivatives, morpholinium, morpholinium derivatives, sulfonium, and sulfonium derivatives; and
at least one anion selected from the group: hexafluorophosphate, hexafluoroantimonate, tetrafluoroborate, bis(trifluoromethylsulfonyl)imide, bis(fluorosulfonyl)imide, chloride, bromide, iodide, dicyanamide, acetate, methylcarbonate, methylsulfate, nitrate, tetrachloroaluminate, thiocyanate, trifluoromethanesulfonate, hydrogen carbonate, dibutylphosphate; and
wherein said dissolved lithium containing salt comprises lithium cations and anions from the group: hexafluorophosphate, hexafluoroantimonate, tetrafluoroborate, bis(trifluoromethylsulfonyl)imide, bis(fluorosulfonyl)imide, chloride, bromide, iodide, dicyanamide, acetate, methylcarbonate, methylsulfate, nitrate, tetrachloroaluminate, thiocyanate, trifluoromethanesulfonate, hydrogen carbonate, and dibutylphosphate.

17. The method of claim 1, wherein said electrochemical cell further comprising an electrolyte layer wherein a first side of said electrolyte layer is in intimate contact across said pressed cathode body.

18. The method of claim 17, further comprising fabricating said electrolyte layer by pressing against said positive cathode powder before said pressed cathode body is created.

19. The method of claim 18 comprising, wherein said electrolyte layer comprises:
materials selected from the group of electronically insulating materials: metal oxides, metal nitrides, metal sulfides, metal fluorides, metal chlorides, metal bromides, metal iodides, borates, carbonates, silicates, germanates, nitrates, phosphates, arsenates, sulfates, selenates, oxyfluorides, oxychlorides, oxybromides, oxyiodides, oxynitrides, carbides, carbonitrides, poly(vinylidene fluoride), poly(tetrafluoroethylene), polyacrylates, polyethylene, polypropylene, polyester, polyamides, polyimides, polyethers, polycarbonates, polysulfones, and silicones; and
further comprising a molten organic salt with dissolved lithium salt, comprising:
at least one cation from the group of: pyrrolidinium, pyrrolidinium derivatives, imidazolium, imidazolium derivatives, phosphonium, phosphonium derivatives, organic ammonium, organic ammonium derivatives, choline, choline derivatives, pyrazolium, pyrazolium derivatives, pyridinium, pyridinium derivatives, piperidinium, piperidinium derivatives, morpholinium, morpholinium derivatives, sulfonium, and sulfonium derivatives;
and at least one anion from the group: hexafluorophosphate, hexafluoroantimonate, tetrafluoroborate, bis(trifluoromethylsulfonyl)imide, bis(fluorosulfonyl)imide, chloride, bromide, iodide, dicyanamide, acetate, methylcarbonate, methylsulfate, nitrate, tetrachloroaluminate, thiocyanate, trifluoromethanesulfonate, hydrogen carbonate, dibutylphosphate; and
wherein said dissolved lithium containing salt comprises lithium cations and at least one anion from the group: hexafluorophosphate, hexafluoroantimonate, tetrafluoroborate, bis(trifluoromethylsulfonyl)imide, bis(fluorosulfonyl)imide, chloride, bromide, iodide, dicyanamide, acetate, methylcarbonate, methylsulfate, nitrate, tetrachloroaluminate, thiocyanate, trifluoromethanesulfonate, hydrogen carbonate, and dibutylphosphate.

20. The method of claim 17, wherein a second side of said electrolyte layer is fabricated in intimate contact across said second side of said electrolyte with a negative anode layer.

21. The method of claim 20, further comprising fabricating said negative anode layer by pressing against said second side of said electrolyte layer.

22. The method of claim 20, wherein said anode layer comprises a material from the group: metallic lithium, metal or metallic alloy that does not alloy with metallic lithium or does only form a solid solution with metallic lithium, and lithium ion anode material that is capable of simultaneously storing lithium ions and electrons.

23. The method of claim 22, wherein said anode layer material further comprises a material from the group: lithium-aluminum alloy, lithium-silicon alloy, lithium-tin alloy, lithium-zinc alloy, lithium-gallium alloy, lithium-indium alloy, lithium-germanium alloy, lithium-phosphorus alloy, lithium-arsenic alloy, lithium-antimony alloy, and lithium-bismuth alloy.

24. The method of claim 23, further comprising fabricating said lithium ion anode material by ball-milling, further comprising priming the walls of the ball-mill vessel with a film of metallic lithium powder.

25. The method of claim 17, further comprising soaking of a liquid electrolyte into the pores of said pressed cathode body and said electrolyte layer after said electrolyte layer has been attached to said pressed cathode body.

26. The method of claim 20, further comprising soaking of a liquid electrolyte into the pores of said pressed cathode body, into the pores of said electrolyte layer, and into the pores of said negative anode layer after said negative anode layer has been attached to said electrolyte layer.

27. The method of claim 1, wherein said positive cathode powder comprises a material from the group: LiCoO₂, LiNiO₂, LiMnO₂, Li₂MnO₃, LiMn₂O₄, LiV₂O₄, LiFePO₄, MnO₂, V2O5, Ag₂V₄O₁₁, CFx (0.5<x<4), and any derivatives and combinations thereof.

28. The method of claim 8, wherein said main axis of said cathode powder particles is the longest distance across said particle.

29. The method of claim 1 wherein said cathode powder contains solid state electrolyte material.

30. The method of claim 29, wherein the energy density of said electrochemical cell is increased by increasing the lithium ion conductivity in said cathode and reducing said porosity to 5 vol %.

31. The method of claim 20, wherein said electrolyte layer is not in contact with said pressed cathode body.

32. The method of claim 31, further comprising soaking of a liquid electrolyte into the pores of said anode layer and said electrolyte layer.
